(19) United States
(12) Patent Application Publication
(10) Pub. No.: US 2014/0337652 A1
(43) Pub. Date: Nov. 13, 2014

(54) ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO. LTD., Shenzhen (CN)

(21) Appl. No.: 14/063,202

(22) Filed: Oct. 25, 2013

(30) Foreign Application Priority Data
May 13, 2013 (CN) 2013101736249

(51) Int. Cl. G06F 1/32

(52) U.S. Cl. CPC G06F 1/3293
USPC 713/323

(57) ABSTRACT

An electronic device is capable of switching between a standby state and a working state. The electronic device includes a power management module, a key module, a detection module, a processor, and a trigger module. When the electronic device is in the standby state, the power management stops outputting a working voltage to the detection module and the detection module is disabled. When the electronic device switches from the standby state into the working state by operating the key module, the trigger module generates a trigger signal. The processor controls the power management module to output the working voltage to the detection module in response to the trigger signal. The detection module detects the pressed key voltage of the key module and generates a pressed signal for controlling the processor to execute a corresponding function.

### BACKGROUND

1. Technical Field

The present disclosure relates to an electronic device.

2. Description of Related Art

Electronic devices, such as DVD player, are capable of switching between a working state and a standby state. Such electronic devices include a plurality of keys, a time controller register (TCON), and a power management chip, and a processor. The TCON powered by the power management chip detects the voltage of the pressed key and controls the processor to execute a corresponding function. When the electronic device is in the standby state, the power management chip stops powering the TCON for saving energy. However, the power management chip does not resume powering the TCON when the electronic device switches from the standby state into working state.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

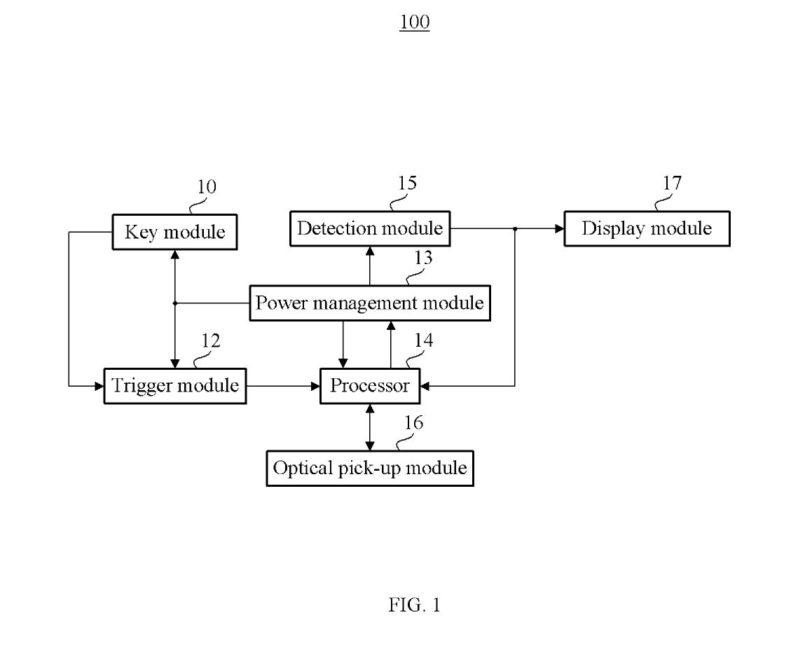

FIG. 1 shows an electronic device 100 of one embodiment of the present disclosure. The electronic device 100 is capable of switching between a power-on state and a standby state. The electronic device 100 disables a function of detecting pressed key when in the standby state, and automatically resumes the function of detecting pressed key when switched from the standby state to the working state. In the embodiment, the electronic device 100 is a DVD player.

The electronic device 100 includes a key module 10, a trigger module 12, a power management module 13, a processor 14, a detection module 15, an optical pick-up module 16, and a display module 17.

The key module 10 outputs different pressed key voltages according to different operations of a user.

The trigger module 12 detects whether the key module 10 outputs a pressed key voltage when the electronic device is in the standby state, and generates a trigger signal to the processor when the key module 10 outputs a pressed key voltage. In the embodiment, the trigger signal is a logic high level signal.

The power management module 13 provides a working voltage to the key module 10, the trigger module 12, and the processor 14.

The processor 14 controls the power management module 13 to provide the working voltage to the detection module 15 in response to the trigger signal. The processor 14 further controls the power management module 13 to stop providing the working voltage to the detection module 15 when the electronic device 100 is in the standby state.

The detection module 15 connects to the key module 10, the power management module 13, and the processor module 14. The detection module 15 detects the pressed key voltage of the key module 10 based on the working voltage, and generates a pressed signal corresponding to the detected pressed key voltage for controlling the processor 14 to execute a corresponding function. In the embodiment, the detection module 15 connects to the key module 10 via a general purpose input output (GPIO) interface, and connects to the processor 14 via an inter integrated circuit (I2C) interface; the detection module 15 is a timing sequential control chip.

The optical pick-up module 16 reads image information from a disc (not shown) and transmits to the processor 14 for decoding.

The detection module 15 further generates a time sequential control signal to the display module 17.

The display module 17 displays the decoded image information based on the time sequential control signal. In the embodiment, the display module 17 is a liquid crystal display, and includes a source driver (not shown) and a gate driver (not shown) which are controlled by the time sequential control signal.

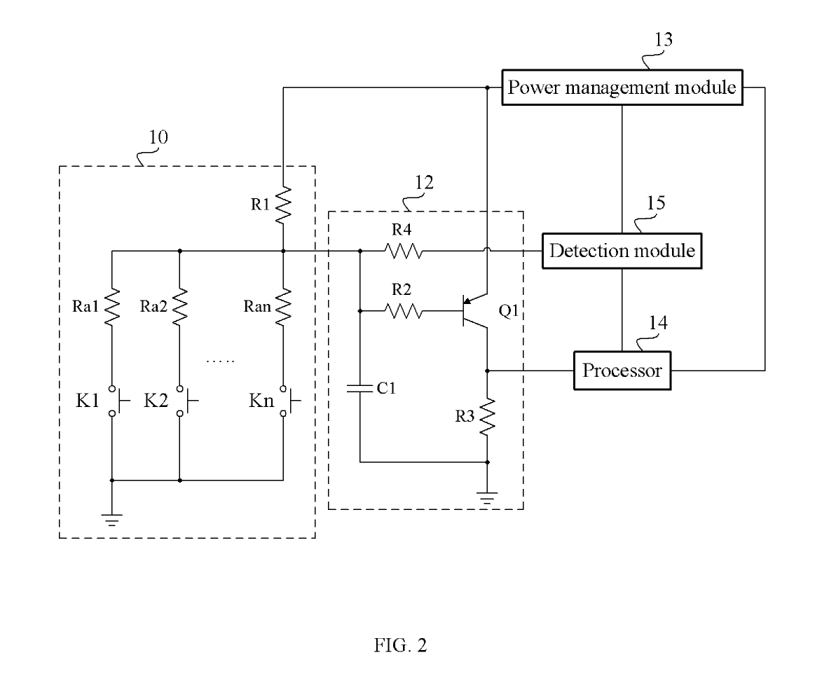

FIG. 2 shows that the key module 10 includes a first resistor R1, a plurality of keys K1-Kn and a plurality of pull-up resistors Ra1-Ran corresponding to the keys K1-Kn in an one-to-one relationship. A terminal of each of the keys K1-Kn is connected to the power management module 13 through the corresponding pull-up resistor Ra1-Ran and the first resistor R1. Another terminal of each of the keys K1-Kn is grounded. The resistances of the pull-up resistors Ra1-Ran are different with each other.

The trigger module 12 includes a transistor Q1, a capacitor C1, a second resistor R2, a third resistor R3, and a fourth resistor R4. A base of the transistor Q1 is connected to the power management module 13 through the first resistor R1 and the second resistor R2. An emitter of the transistor Q1 is connected to the power management module 13. A collector of the transistor Q1 is grounded through the third resistor R3. A first terminal of the capacitor C1 is connected to the power management module 13 through the first resistor R1. A second terminal of the capacitor C1 is grounded. A terminal of the fourth resistor R4 is connected to the power management module 13 through the first resistor R1. Another terminal of the R4 is connected to the detection module 15. In the embodiment, the transistor Q1 is a pnp type bipolar junction transistor.

The working principle of the electronic device 300 is described, when the processor 14 is in the standby state, the power management module 13 stops providing the working voltage to the detection module 15. When any of the keys K1-Kn is pressed, the voltage difference between the base and the emitter of the transistor Q1 is less than 0.7 volt (V), and the transistor Q1 turns on and outputs a logic high level signal. The processor 14 switches into the working state based on the logic high level signal. The power management module 13 provides the working voltage to the detection module 15. As a result, the power management module 13 resumes powering the detection module 15 when the electronic device 100 switches from the standby state into the working state, and the key module 10 connects to the detection module 15 for reducing the GPIO interfaces of the processor 14.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device capable of switching between a working state and a standby state, comprising:
a power management module;
a key module outputting different pressed key voltages according to different operations of a user;
a detection module connected to the key module, and capable of detecting the pressed key voltage and outputting a corresponding pressed signal based on the detected result when being powered;
a processor capable of executing different function in response to the pressed signal generated by the detection; and
a trigger module connected to the processor and the key module, and detecting whether the key module outputs a pressed key voltage when the electronic device is in the standby state;
wherein when the electronic device is in the standby state, the power management stops outputting a working voltage to the detection module and the detection module is disabled, when the electronic device switches from the standby state into the working state by operating the key module, the trigger module generates a trigger signal, and the processor controls the power management module to output the working voltage to the detection module in response to the trigger signal; the detection module is enabled to detect the pressed key voltage of the key module.

2. The electronic device of claim 1, wherein the key module comprises a plurality of keys, and each of the keys is connected to the detection module via an inter integrated circuit (I2C) interface.

3. The electronic device of claim 1, wherein the detection module connects with the processor via a general purpose input output (GPIO) interface.

4. The electronic device of claim 1, further comprising a display module; wherein when being powered by the working voltage, the detection module further generates a time sequential control signal; the display module display images based on the time sequential control signal.

5. The electronic device of claim 4, wherein the trigger module comprises a transistor, a capacitor, a first resistor, and a second resistor; a base of the transistor is connected to the power management module through the first resistor, an emitter of the transistor is connected to the power management module; a collector of the transistor is grounded through the second resistor; a first terminal of the capacitor is connected to the power management module; a second terminal of the capacitor is grounded.

6. The electronic device of claim 5, wherein the transistor is a pnp type bipolar junction transistor.

7. An electronic device capable of switching between a working state and a standby state, comprising:
a key module capable of outputting different pressed key voltage according to different operations of a user;
a detection module connected between the key module, capable of detecting the pressed key voltage when being powered by the working voltage and outputting a corresponding pressed signal based on the detected result; and
a processor connected to the detection module, and capable of executing different function in response to the pressed signal generated by the detection;
wherein only one general purpose input output (GPIO) interface of the processor is used for connecting with the detection module.

8. The electronic device of claim 7, further comprising a power management module and a trigger module; wherein the power management module outputs a working voltage for powering the detection module when the electronic device is in the working state, the trigger module connected to the key module detects whether the key module outputs a pressed key voltage when the electronic device is in the standby state; when the key module outputs a pressed key voltage, the trigger module generates a trigger signal, the processor controls the power management module to output the working voltage to the detection module in response to the trigger signal; the detection module is enabled.

9. The electronic device of claim 8, wherein the trigger module comprises a transistor, a capacitor, a first resistor, and a second resistor; a base of the transistor is connected to the power management module through the first resistor, an emitter of the transistor is connected to the power management module; a collector of the transistor is grounded through the second resistor; a first terminal of the capacitor is connected to the power management module; a second terminal of the capacitor is grounded.

10. The electronic device of claim 9, wherein the transistor is a pnp type bipolar junction transistor.

11. The electronic device of claim 8, further comprising a display module; wherein when being powered by the working voltage, the detection module further generates a time sequential control signal; the display module display images based on the time sequential control signal.

12. The electronic device of claim 7, wherein the key module comprises a plurality of keys; each of the keys is connected to the detection module via an inter integrated circuit (I2C) interface.
